(19) United States
(12) Patent Application Publication
(10) Pub. No.: US 2005/0055265 A1
(43) Pub. Date: Mar. 10, 2005

(54) Method and system for analyzing the usage of an expression

(76) Inventor: Terrence Paul McFadden, Cincinnati, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 10/655,834

(22) Filed: Sep. 5, 2003

(51) Int. Cl. G06F 17/60

(52) U.S. Cl. 705/10

(57) ABSTRACT

Methods and systems are directed to analyzing the usage of an expression. More particularly, the method and system can be used to track and analyze trends associated with an expression being used by an organization, such as Internet sites.

### TECHNICAL FIELD

The present invention relates generally to methods and systems for analyzing the usage of an expression. More particularly, the method and system can be used to track and analyze trends associated with an expression being used by an organization, such as Internet sites.

### BACKGROUND OF THE INVENTION

Understanding how to market your products and services, develop new markets and track what others in a particular industry are involved with is important in succeeding in the marketplace. Product development has become increasingly important in any industry, and as such, numerous methods and systems exist today which can help companies evaluate how to better market their products and/or services. Many of these available services are offered as a means to develop a better marketing scheme, primarily focused on Internet marketing. Traditional Internet search engines used by consumers to search for desired sites using particular terms or phrases can be manipulated to increase a company's odds of being found by the consumer by having the company's website ranked higher in the search engine results. These ranking techniques have provided a valuable service to numerous companies, particularly those that are not well known in the marketplace. They provide such entities a larger audience due to the growth and expansion of the Internet. In addition, traditional search engines have allowed not only consumers, but also companies, to evaluate what other companies and potential entrants into a particular market or industry are becoming involved with based on the way these companies are marketing on their respective websites, or on other related websites where those in the industry advertise.

In addition to search engines, another service that is available to individuals and companies interested in monitoring particular markets, are alert systems, which provide pockets of information offered on a regular basis. For example, these alerts may provide news clippings about a new drug that a company is developing, a new marketing strategy that a particular competitor may be undertaking, or a new service that a company may be providing to the public. The alert system is a fairly continuous service which can provide users with, for example, day-to-day updates of events happening in a particular industry. However, these alerts only provide pockets of information which are difficult to separate and evaluate from the industry as a whole so as to develop a better understanding of what is happening in the industry on a more global scale.

Traditional search engine technology and alert system services that are available do not provide an encompassing understanding of information associated with an entire industry or market. Tracking products or services in which a user may be interested, particularly in regards to terms or phrases, populating particular Internet sites, purchase data, internal databases developed by companies or any other organization can be extremely valuable. For example, tracking on a continual basis particular marketing strategies directed to various categories such as advertising spending for various organizations could prove most useful.

### SUMMARY OF THE INVENTION

Accordingly, it is an aspect of the present invention to provide a method and system for analyzing the usage of an expression.

To achieve the foregoing and other aspects, and in accordance with the purposes of the present invention defined herein, a method for analyzing the usage of an expression is provided. The method includes monitoring a selected organization for occurrences a selected expression within a time interval. Then, predetermined attributes of each occurrence of the expression are gathered. Each occurrence of the expression and its predetermined attributes are then stored in association with the time interval. Next, the monitoring of the organization, gathering of the predetermined attributes and storing of each occurrence of the expression and its predetermined attributes are repeated at a subsequent time interval. Finally, the number of occurrences of the expression in the organization are compiled as a function of time and the resulting compilation is stored in a user accessible medium.

In another exemplary embodiment of the present invention, a method for analyzing the usage of an expression includes analyzing a compilation of the number of occurrences of a selected expression in a selected organization as a function of time to determine a trend associated with the occurrences of the expression in the organization.

In yet another exemplary embodiment of the present invention, a system for analyzing the usage of an expression is provided. The system includes a first data storage system comprising an organization within a time interval. The system also includes a monitoring tool configured to monitor the organization for occurrences of an expression. A second data storage system is also included in the system and is configured to store each occurrence of the expression and its predetermined attributes in association with the time interval. Finally, the system includes a computer program configured to compile the number of occurrences of the expression in the organization as a function of time and store the resulting compilation in a user accessible medium.

The methods and systems for analyzing the usage of an expression described herein are advantageous for providing an analysis tool for determining the occurrences of an expression within an organization. Additional aspects, advantages, and novel features of the invention will be set forth in the description that follows, and/or will become apparent to those skilled in the art upon examination of the following, and/or may be learned with the practice of the invention. The aspects and advantages of the invention may be realized and obtained by means of the instrumentalities and combinations particularly pointed out in the appended claims.

### BRIEF DESCRIPTION OF THE DRAWINGS

While the specification concludes with claims particularly pointing out and distinctly claiming the present invention, it is believed that the same will be better understood from the following description taken in conjunction with the accompanying drawings in which:

FIG. 1 depicts a schematic layout illustrating one exemplary embodiment of the method for analyzing the usage of an expression within an organization; and

FIG. 2 illustrates a schematic layout showing one exemplary embodiment of the system for analyzing the usage of an expression within a plurality of organizations.

### DETAILED DESCRIPTION OF EXEMPLARY EMBODIMENTS

The present invention provides particular advantages previously unavailable which allow users to track not only what competitors are doing in a particular industry, but also what other entities perhaps related to the industry may be attempting to do in the market, e.g., what new products or services they may be developing. The present invention allows for a user to analyze over time the usage of an expression, such that the user can monitor potential developing trends in particular defined organizations. This is achieved by improving the signal-to-noise ratio when analyzing the occurrence of the expression over time, allowing the user to visually determine which organizations are trafficking specific expressions. The user can evaluate not only on a continuous basis, but also on global scale, so that instead of obtaining only a snapshot of the industry as would be provided, for example, by an alert service, the user receives a better understanding of the trends associated with the entire marketplace as a whole. Therefore, the user is provided a better opportunity to monitor changes as they occur over time in the industry versus the pockets of information the user may be able to obtain in other ways.

In addition, this present invention provides flexibility to the user allowing them to select an expression they wish to evaluate as well as the organizations they want to monitor. The flexibility allows the user to update the organizations being monitored on a regular basis permitting the user to include new organizations or eliminate out-of-date organizations. This is particularly advantageous where the user needs to maximize the accuracy of the data obtained by eliminating potentially false or misleading data that can effect the developing trend.

The present invention includes a method for analyzing the usage of an expression. The method includes monitoring a selected organization for occurrences a selected expression within a time interval. Predetermined attributes of each occurrence of the expression are gathered. Each occurrence of the expression and its predetermined attributes are then stored in association with the time interval. The monitoring, gathering, and storing is then repeated at a subsequent time interval. Finally, the number of occurrences of the expression in the organization are compiled as a function of time and stored in a user accessible medium.

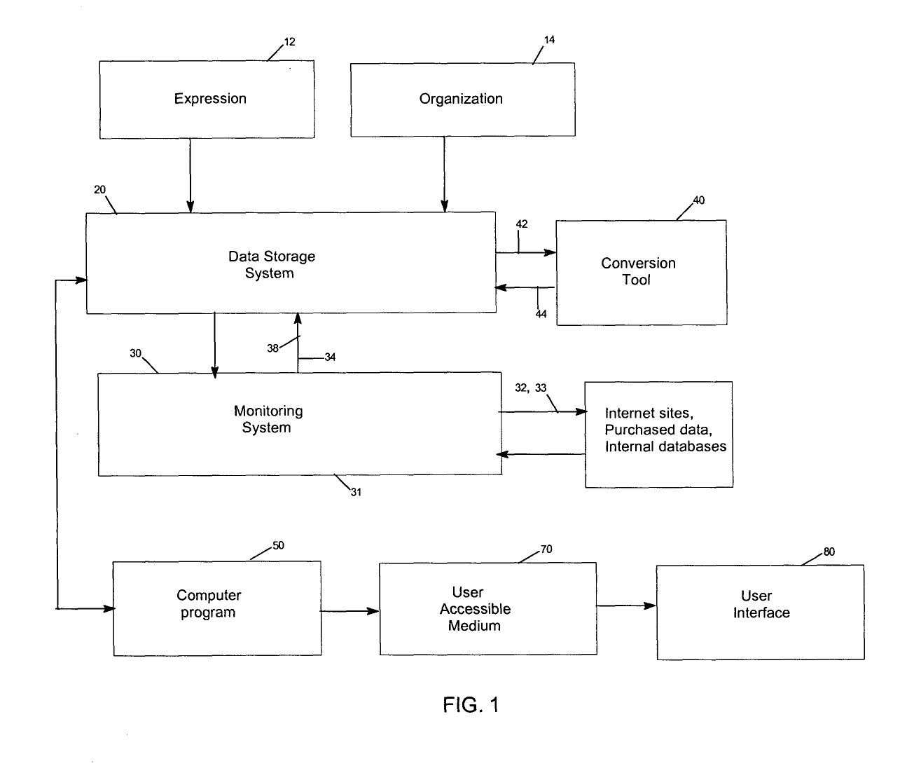

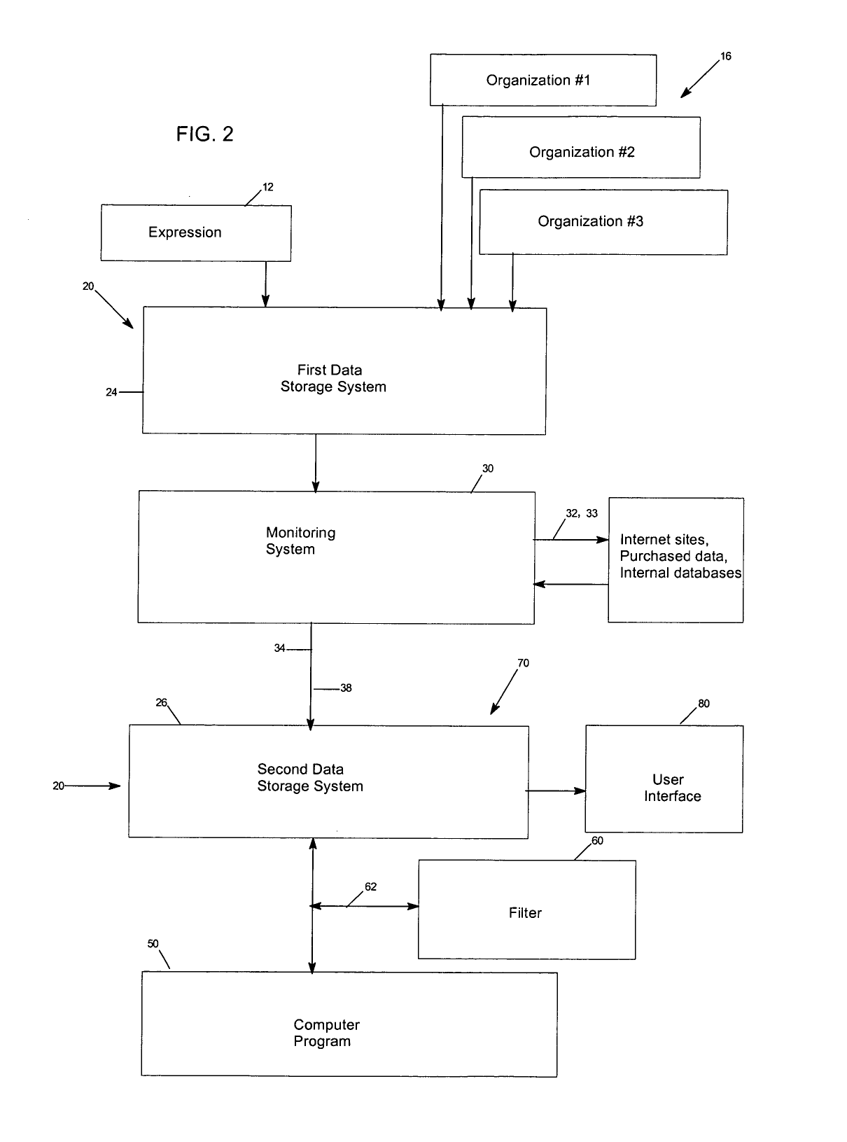

Exemplary embodiments of the present invention and its operation are herein described in detail in connection with the views and examples of FIGS. 1-2, wherein like numbers indicate the same or corresponding elements throughout the views. FIG. 1 depicts one exemplary embodiment of the method for analyzing the usage of an expression 12 within an organization 14 to determine a trend of the usage of the expression 12 as a function of time.

Depicted in FIG. 1 is the selection of an expression 12. An expression 12 can include a specific term, phrase, symbol, number or combination thereof in which a user may be interested in tracking in a particular industry or market (e.g., “orange,” “shiny hair,” “blue” and “sales,” “2003” or “03”). A user can select or predetermine the expression 12 in order to evaluate or determine how the expression 12 is being used in a particular market or industry. The user can develop one or a plurality of expressions 12 that can be maintained in a data storage system 20, such as a relational database, for tracking during regular time intervals. The data storage system 20 can include databases, data warehouses, or any type of computer readable medium which can store and maintain the expression 12. As will be readily appreciated, computer-readable medium can take a variety forms, including magnetic storage (such as hard disk drives, floppy diskettes, etc.), optical storage (such as laser disks, compact disks, DVD's, etc.), electronic storage (such as random access memory “RAM”, read-only memory “ROM”, programmable readable-only memory “PROM”, etc.), and the like. The ability to select an expression 12 is advantageous in that it provides the user the flexibility to pick and choose what it believes is the most significant expression 12 to evaluate in a designated market or industry.

Once the expression 12 has been predetermined and assembled within the data storage system 20, the user selects which organization 14 it considers to be related to the expression 12 and valuable to track with respect to the occurrences of the selected expression 12. This organization 14 is predefined in a manner selected by the user which once again provides the user with a significant advantage allowing them to evaluate and select which organization 14 it believes should be tracked, particularly those in a specific market or industry. Moreover, this organization 14 includes various sources. For example, the organization 14, once predefined by the user, can encompass one or a plurality of Internet websites in HTML (including threaded discussions on extranets/intranets and chat rooms), purchased data where the user has access to databases or data warehouses that can be purchased, or internal databases that the user may maintain (e.g., email content, tabular data). Internet websites can include the websites of a user's direct or indirect competitors in the market, or a collection of market websites. The Internet website includes the entire index, including all of the embedded links and documents associated with the website. These types of organizations 14 incorporate a significant volume of data and information that is regularly updated, which provides an incentive for the user to track and evaluate these updated changes over time in hopes of discovering a trend or relationship between the user's expression 12 and associated organization 14. For example, if the user wants to monitor whether its expression 12 occurs on the website of a competitor, it can do so in a manner that allows it to track each occurrence of the expression 12 within the organization 14.

Once the expression 12 and the organization 14 are selected and stored in the data storage system 20, the designated organization 14 is then monitored by a monitoring system 30 as depicted in FIGS. 1 and 2. This monitoring allows for the user to determine the usage of the expression 12 within the organization 14. In one exemplary embodiment, monitoring can include crawling 32 and mining 34 the organization 14. Various techniques such as crawling 32 or spidering 33 are commonly used in association with Internet websites which allow a user to evaluate and extract the entire index of a given website and collect the textual content 44 of the website. The textual context 44 includes all the words, numbers and symbols stored within the matrix of the websites index. Crawling 32 and/or spidering 33 allows the user to evaluate the structured content on a website by collecting the data and turning it into unstructured content in the form of text. As with websites, other organizations 14 such as purchased data and internal databases can also be crawled or spidered providing all the words, numbers and symbols associated with the organization 14. Once the organization 14 has been crawled or spidered, the index of words, numbers and symbols are then mined for the expression 12. Mining 34 allows for the flagging or marking of occurrences of the expression 12 being tracked by the user. Once an occurrence, or hit, of the expression 12 is located within the matrix of the textual content 44, the occurrence and its predetermined attributes 38 are gathered in association with the time interval, and a record of the occurrence is stored in a data storage system 20 along with the predetermined attributes 38 associated with the occurrences or hits that are flagged from mining 34 the index of words, numbers and symbols from the organization 14.

The predetermined attributes 38 of the occurrences can include various attributes associated with the organization 14 that can be gathered or collected along with the occurrences of the expression 12. For example, the organization 14, such as a website, can have attributes which include the website's URL where each particular occurrence of the expression 12 is found within the website, date/time stamping associated with the occurrences, and company information associated with the website. Such predetermined attributes 38 permit the user to correlate a particular page on a website or the time stamping of that particular page with occurrences of the expression 12. This knowledge can be advantageous, especially where the user can return to that particular URL and examine how the expression 12 is being used, specifically to see how the selected expression 12 is being applied to a marketing strategy or how it is being used in relationship to a particular product or service being developed by a competitor.

Although the textual content 44 of the organization 14 is what is monitored, in another exemplary embodiment the method can include evaluating audio content 42 associated with an organization 14. However, this embodiment further includes converting the audio content 42 of a given organization 14 to textual content 44 prior to monitoring the organization 14 using the crawling 32 and mining 34 techniques. For example, the audio content 42 could include recorded speech, music or computer generated verbal expressions which can all then be converted using a conversion tool 40 (as illustrated in FIG. 1) to textual content 44 which can then be monitored. In another exemplary embodiment, a digital feed containing closed captioning information on a video blank interval can also be monitored.

The number of occurrences of the expression 12 that occur within the organization 14 are monitored during time intervals. The time interval can range depending on how often the user monitors the organization 14 and how much data they want to analyze. The time interval can be hourly, daily, weekly, monthly, annually or any particular standard time interval the user chooses to monitor. In one exemplary embodiment, the monitoring is repeated through subsequent time intervals. For example, if the organization 14 is monitored on a daily basis, a user can track changes that occur within the organization 14 from day-to-day.

The predetermined attributes 38 associated with the occurrences of the expression 12 can also stored in the data storage system 20 as depicted in FIG. 1. The data storage system 20 can include a relational database in one exemplary embodiment, which can be configured to allow a computer program 50 to analyze the information associated with the occurrences of the expression 12 as a function of time. In another exemplary embodiment, as depicted in FIG. 2, the data storage system 20 can comprise first and second data storage systems 24, 26. Thus, in order to determine the usage of the expression 12 as a function of time, the monitoring of the organization 14 for the occurrences of the expression 12, the gathering of the predetermined attributes 38 of each occurrence of the expression 12, and the storing of each occurrence of the expression 12 and its predetermined attributes 38 that are associated with that particular time interval are repeated. The repetition of the monitoring, gathering and storage from an initial time interval through subsequent time intervals provides for the compiling of the number of occurrences of the expression 12 in the organization 14 as a function of time. In another exemplary embodiment, the repeating of the monitoring, gathering and storing occurs at a plurality of subsequent time intervals. The subsequent time interval can be one day.

In one exemplary embodiment of the invention as depicted in FIG. 2, the method includes selecting a plurality of organizations 16, monitoring the plurality of organizations 16 and compiling the number of occurrences of the expression 12 in at least a portion of the plurality of organizations 16 as a function of time. In one exemplary embodiment, the number of occurrences of the expression 12 in all of the plurality of organizations 16 are compiled. Selecting a plurality of organizations 16 provides the user the capability to analyze the use of a expression 12 with respect to a grouping of organizations 14, such as the websites of direct competitors. This gives the user a much broader understanding of the usage of its expression 12 on a more global scale, for example, allowing the user to determine trends across a market or industry. In another exemplary embodiment, not all of the plurality of the organizations 16 are compiled. For example, the number of occurrences of the expression 12 in less than all of the plurality of organizations 16 which are compiled can be considered a subset. The subset could perhaps include what the user defines as its direct competitors in a particular market or perhaps a subset having a particular set of organizations 14 associated with news and news-related information pertaining to a designated market or industry.

One aspect of using this method is the ability to also consider information that might be associated with the user particularly information the user may want to filter. In another exemplary embodiment, the method includes filtering 62 some occurrences of the expression 12 and the associated predetermined attributes 38 by means of a filter 60 as illustrated in FIG. 2. Filtering 62 this “bad data” from the “good data” is necessary so that the occurrences included within the resulting compilation provide more accurate and true results that can then later be analyzed. In filtering 62 the occurrences of the expression 12 and its associated predetermined attributes 38, subsequent analysis provides a more useful understanding of the usage of the expression 12 in a particular market that the user wants to monitor or evaluate. For example, if one were to monitor an expression 12 such as “water,” using such a broad term, even within well-defined organizations 14, would be so encompassing that the associated data from the well-defined organizations 14 would prove useless and give an overabundance of information which would provide no valuable trends associated with particular markets or industries. However, in such situations, when certain occurrences are filtered out, the remaining occurrences of the expression 12 can prove to be valuable, particularly in regards to the usage of the expression 12 by a competitor's website or associated website in the market or industry.

Finally, the method also includes compiling the number of occurrences of the expression 12 in the organization 14 as a function of time and storing the resulting compilation in a user accessible medium 70. The user accessible medium 70 includes any type of computer readable medium known and appreciated by those skilled in the art for storing the resulting compilation. The resulting compilation can be analyzed to determine trends in a particular market providing the user a valuable tool in evaluating potential new markets or giving the user better insight into existing markets. A computer program 50, as depicted in FIGS. 1 and 2 is configured to compile the number of occurrences of the expression 12 in the organization 14 as a function of time. The computer program 50 allows the user flexibility in evaluating trends that have been determined with respect to the occurrences of an expression 12 as a function of time. Typical computer programs 50 can include EXCEL, SPOTFIRE®, SAS (statistical analysis system) and other various programs that can produce control charts to evaluate trends determined from the occurrences of the expression 12 as a function of time. However, to provide the user greater capability, the computer program 50 can also include a relational database for example, ORACLE® or SQL Server® databases, and custom created JAVA® applets and/or servlets providing full browser-enabled application to analyze the occurrences of the expression 12.

Once the number of occurrences of the expression 12 has been determined as a function of time, the information can be analyzed and evaluated by the computer program 50 in determining whether or not a trend exists in regards to how organizations 14, such as a competitors and/or potential competitors, are developing and marketing a particular product or service. Embedded within the trend is also the associated predetermined attributes 38 such as the website URL, company information, time stamping, date information and any other data associated with each of the occurrences of the expression 12. The computer program 50 can allow the user to simply choose a particular date from the developed line chart and examine the information associated with that particular date, for example, the number of hits of a particular expression 12 in association with each of the organizations 14 that were monitored on that day, and/or information specific to the predetermined attributes 38. This capability allows the user to drill down from a global trend analysis associated with an industry and consider a snapshot of a particular time interval in evaluating the occurrences of a particular expression 12 within that single time interval and the organizations 14 having occurrences of the expression 12.

In one exemplary embodiment, the method can further include outputting the resulting stored compilation of the usage of an expression 12 as a function of time on a user interface 80. The user interface 80 may comprise a computer system comprising a computer processing unit (CPU), memory, a visual display device and an input means. Exemplary input means may comprise a keyboard or mouse or other means of input such as speech recognition and/or visual input. The visual display device, such as a monitor or screen, can be configured to display a graphical analysis of the resulting compilation. The graphical analysis can include various types of comparative analysis, such as statistical analysis (e.g., Markhov, Bayesian methods), which may be illustrated in various formats such as a histogram, line chart, clustering, geographic based techniques, or various other graphical representations. In one particular embodiment, the statistical analysis provides statistically significant increases and/or declines in the occurrences of the expression 12, including a standard deviation of about +/−2. The statistical analysis serves to reduce the signal-to-noise ratio so that the user can obtain accurate and true information regarding the occurrences of the expression 12. The user can also obtain a storyline which reports on a given topic (e.g., new company) detailing the captured predetermined attributes 38 associated with the occurrences of the expression 12 over specified intervals of time. This visual aspect depicting the usage of an expression 12 as a function of time provides the user with another tool in evaluating the usage of the expression 12. In another exemplary embodiment, the user can access the stored predetermined attributes 38 of the occurrences at a selected time interval. Particularly, the accessed stored attributes of the occurrences at a selected time interval can be displayed on a user interface 80, such as a monitor.

FIG. 2 depicts a system for analyzing the usage of an expression 12 includes a first data storage system 24 having an organization 14 within a time interval. The system also includes a monitoring tool 31 which is configured to monitor the organization 14 for occurrences of the expression 12. Using crawling 32 or spidering 33 programs in combination with a mining 34 package, as the monitoring tool 31, allows the user to monitor textual content associated with an organization 14 to locate the occurrences of the expression 12. The system further includes a second data storage system 26 where each occurrence of the expression 12 and its predetermined attributes 38 associated with the time interval are stored. The first and second data storage systems 24, 26 can include databases, data warehouses, or any type of computer readable medium which can store and maintain the associated information. For example, each occurrence of the expression 12 and its associated predetermined attributes 38 may be stored on a relational database which allows the user flexibility in compiling the information associated with the number of occurrences that have been found within the organization 14. Finally, the system further includes a computer program 50 configured to compile the number of occurrences of the expression 12 in the organization 14 as a function of time and store the resulting compilation in a user accessible medium 70.

In one exemplary embodiment, the system can further include a filter 60 configured to substantially eliminate each occurrence of the expression 12 and predetermined attributes 38 associated with the user. As previously mentioned, a filter 60 can serve to increase the accuracy of the statistical analysis performed by the computer program 50, buy eliminating “bad data” or false positives as defined by the user. In another exemplary embodiment, the system can also include a user interface 80 configured to display the number of occurrences of the expression 12 in the organization 14 as a function of time. In one particular exemplary embodiment the user interface 80 is a monitor. The resulting compilation is output from the user accessible medium 70 to the user interface 80, to allow the user to analyze trends associated with the resulting compilation.

The present invention also provides a computer-readable storage medium having executable code for instructing a computer to perform the following: monitor a selected organization 14 for occurrences of a selected expression 12 within a time interval, gather predetermined attributes 38 of each occurrence of the expression 12, store each occurrence of the expression 12 and its predetermined attributes 38 in association with the time interval, repeat the monitoring, gathering and storing at a subsequent time interval, and compile the number of occurrences of the expression 12 in the organization 14 as a function of time and store the resulting compilation in a user accessible medium 70.

The methods and systems as described above are particularly useful in devising marketing strategies and tracking competitors as well as new entrants into particular markets, but the present invention can also be applied in numerous other ways. For example, they can be applied to track financial trends, political and social trends, and many other aspect that will be learned from practicing the invention.

The foregoing description of exemplary embodiments and examples of the invention have been presented for purposes of illustration and description. It is not intended to be exhaustive or limit the invention to the forms described. Numerous modifications are possible in light of the above teachings. Some of these modifications have been discussed, and others will be understood by those skilled in the art. The embodiments have been chosen and described in order to best illustrate the principles of the invention and various embodiments as they are suited in the particular use contemplated. It is hereby intended that the scope of the invention be defined by the claims appended hereto.

1. A method for analyzing the usage of an expression, comprising:
monitoring a selected organization for occurrences of a selected expression within a time interval;
gathering predetermined attributes of each occurrence of the expression;
storing each occurrence of the expression and its predetermined attributes in association with the time interval;
repeating the monitoring, gathering, and storing at a subsequent time interval; and
compiling the number of occurrences of the expression in the organization as a function of time and storing the resulting compilation in a user accessible medium.

2. The method according to claim 1, wherein the method comprises monitoring a plurality of organizations and compiling the number of occurrences of the expression in at least a portion of the plurality of organizations as a function of time.

3. The method according to claim 2, wherein the number of occurrences of the expression in all of the plurality of organizations are compiled.

4. The method according to claim 2, wherein the number of occurrences of the expression in less than all of the plurality of organizations are compiled in a subset.

5. The method according to claim 1, wherein the expression comprises a term or phrase.

6. The method according to claim 1, wherein the organization comprises textual content.

7. The method according to claim 1, wherein the organization comprises Internet websites, purchased data, or internal databases.

8. The method according to claim 1, wherein prior to monitoring, the organization is assembled in a data storage system.

9. The method according to claim 1, wherein the repeating of the monitoring, gathering and storing occurs at a plurality of subsequent time intervals.

10. The method according to claim 1, wherein each subsequent time interval is one day.

11. The method according to claim 1, wherein the predetermined attributes comprise time-stamping, website URL, and company information.

12. The method according to claim 1, wherein the occurrences of the expression and predetermined attributes are stored in a data storage system.

13. The method according to claim 1, further comprising analyzing the resulting compilation of occurrences of the expression to determine a trend associated with the occurrences of the expression in the organization.

14. The method according to claim 1, further comprising outputting the stored compilation to a user interface.

15. The method according to claim 14, wherein the user interface comprises a visual display device configured to display a graphical analysis of the resulting compilation.

16. The method according to claim 1, further comprising converting the organization from an audio content to textual content.

17. The method according to claim 1, further comprising filtering the occurrences of the expression and the associated predetermined attributes generated from repeating the monitoring, gathering and storing.

18. The method according to claim 1, further comprising providing access to the stored predetermined attributes of the occurrences associated with a selected time interval for display on a user interface.

19. A computer-readable storage medium, comprising executable code for instructing a computer to perform the method of claim 1.

20. A method for analyzing the usage of an expression, comprising analyzing a compilation of the number of occurrences of a selected expression in a selected organization as a function of time to determine a trend associated with the occurrences of the expression in the organization.

21. A system for analyzing the usage of an expression, comprising:
a first data storage system comprising an organization within a time interval;
a monitoring tool configured to monitor the organization for occurrences of the expression;
a second data storage system configured to store each occurrence of the expression and its predetermined attributes in association with the time interval; and
a computer program configured to compile the number of occurrences of the expression in the organization as a function of time and store the resulting compilation in a user accessible medium.

22. The system according to claim 21, further comprising a filter configured to substantially eliminate each occurrence of the expression and predetermined attribute associated with a user.

23. The system according to clam 22, further comprising a user interface configured to display the number of occurrences of the expression in the organization as a function of time.
